(19) United States
(12) Patent Application Publication
(10) Pub. No.: US 2011/0124839 A1
(43) Pub. Date: May 26, 2011

(54) FLAME-RETARDANT POLYESTER COPOLYMER, AND PRODUCTION PROCESS AND MOLDED ARTICLE THEREOF

(75) Inventors: Katsuhiro Matsuda, Kawasaki-shi (JP); Kenji Ito, Chiba-shi (JP); Sumire Kubota, Kawasaki-shi (JP); Atsushi Fuseya, Tokyo (JP); Hiroshi Shinagawa, Yokohama-shi (JP)

(73) Assignee: CANON KABUSHIKI KAISHA, Tokyo (JP)

(21) Appl. No.: 12/946,431

(22) Filed: Nov. 15, 2010

(30) Foreign Application Priority Data
Nov. 25, 2009 (JP) 2009-267967

(51) Int. Cl. C08G 63/66

(52) U.S. Cl. 528/365

(57) ABSTRACT

The invention provides a production process of a flame-retardant polyester copolymer, having a first step of adding a catalyst to a 2,5-furan dicarboxylic acid compound, an aliphatic or alicyclic diol, itaconic acid and 9,10-dihydro-9-oxa-10-phosphaphenanthrene-10-oxide to obtain an oligomer, and a second step of adding a catalyst to the oligomer obtained in the first step to conduct polycondensation, thereby obtaining the flame-retardant polyester copolymer.

### BACKGROUND OF THE INVENTION

1. Field of the Invention

The present invention relates to a flame-retardant polyester copolymer, and a production process and molded article thereof.

2. Description of the Related Art

Polyethylene-2,5-furan dicarboxylate (hereinafter referred to as “PEF”) is expected to be applied to a plastic for casings in electric appliances such as printers because its structure is close to polyethylene terephthalate (hereinafter referred to as “PET”). 2,5-Furan dicarboxylic acid that is a raw material of PEF can be synthesized from a renewable material such as a saccharide, so that PEF attracts attention as a material effective in reducing the amount of petroleum resources used. However, PEF has been unable to achieve high flame retardancy such as V-0 or V-1 in UL94 (Underwriters Laboratories-94) Standard by itself and'has been unable to be used in members of which high flame retardancy is required, such as casings and internal parts of copying machines. Thus, its usable applications have been limited (Japanese Patent Application Laid-Open No. 2007-146153).

As a method for imparting flame retardancy to PET, it is known to improve the flame retardancy by kneading a reaction product of itaconic acid, ethylene glycol and 9,10-dihydro-9-oxa-10-phosphaphenanthrene-10-oxide (hereinafter referred to as “DOPO”) into PET as described in International Publication WO 2007/040075. However, the thickness of a specimen for burning test has been as thick as 3.2 mm to fail to impart high flame retardancy (V-0) in such a thickness of 2 mm as used as a casing of a copying machine.

### SUMMARY OF THE INVENTION

The present invention has been made in view of the foregoing circumstances and has as its object the provision of a process for producing a polyester copolymer having high flame retardancy in such a thickness of 2 mm as used as a casing of a copying machine.

The present inventors have carried out an extensive investigation. As a result, a production process of an ester copolymer whose flame retardancy is improved to that corresponding to V-0 has been found. The production process of a flame-retardant polyester copolymer according to the present invention comprises a first step of adding a catalyst to a 2,5-furan dicarboxylic acid compound represented by the following formula (1), an aliphatic or alicyclic diol, itaconic acid and 9,10-dihydro-9-oxa-10-phosphaphenanthrene-10-oxide to obtain an oligomer, and a second step of adding a catalyst to the oligomer obtained in the first step to conduct polycondensation, thereby obtaining the flame-retardant polyester copolymer.

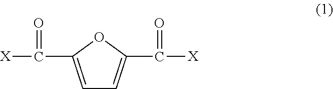

wherein X is a hydroxyl group, alkoxy group or halogen atom.

The flame-retardant polyester copolymer according to the present invention is obtained by polycondensing an ester compound of a 2,5-furan dicarboxylic acid compound represented by the following formula (1) and an aliphatic or alicyclic diol, itaconic acid and 9,10-dihydro-9-oxa-10-phosphaphenanthrene-10-oxide and has a number average molecular weight of 10,000 or more and 200,000 or less.

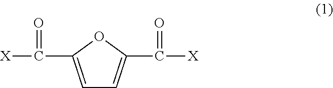

wherein X is a hydroxyl group, alkoxy group or halogen atom.

The molded article according to the present invention is obtained by molding the above-described flame-retardant polyester copolymer.

In the flame-retardant polyester copolymer by the production process according to the present invention, high flame retardancy corresponding to V-0 in UL94 Standard is achieved, and this polyester copolymer can be used in members of casings and internal parts of copying machines, of which flame retardancy is required, and which have a thickness of 2 mm.

Further features of the present invention will become apparent from the following description of exemplary embodiments.

### DESCRIPTION OF THE EMBODIMENTS

Preferred embodiments of the present invention will now be described in detail. Incidentally, individually disclosed embodiments are examples of the flame-retardant polyester copolymer according to the present invention, and the production process and molded article thereof, and the present invention is thus not limited thereto.

### First Embodiment

First, the structure of the flame-retardant polyester copolymer that is a first embodiment of the present invention is described. The first embodiment of the present invention is characterized in that a 2,5-furan dicarboxylic acid compound represented by the formula (1), an aliphatic or alicyclic diol, itaconic acid represented by the formula (2) and DOPO (9,10-dihydro-9-oxa-10-phosphaphenanthrene-10-oxide) represented by the formula (3) are polycondensed.

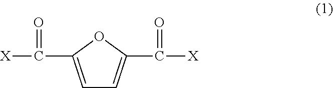

wherein X is a hydroxyl group, alkoxy group or halogen atom. In the formula (1), the alkoxy group is favorably a methoxy or ethoxy group.

The 2,5-furan dicarboxylic acid compound represented by the formula (1) is favorably produced from the so-called plant derivative (biomass) such as cellulose, glucose and fructose by a publicly known process.

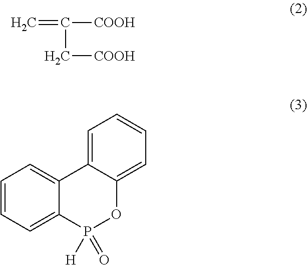

In the present invention, the following compounds may be used as the aliphatic or alicyclic diol. As open-chain or cyclic aliphatic diols, may be used ethylene glycol, 1,3-propanediol, 1,4-butanediol and 1,4-cyclohexanedimethanol. Among these, ethylene glycol represented by the formula (4) is favorable. When ethylene glycol is used, the structure of the flame-retardant polyester copolymer according to the present invention is represented by the formula (5). A favorable molecular weight (number average molecular weight) range of the flame-retardant polyester copolymer according to the present invention is 10,000 or more and 200,000 or less, favorably 30,000 or more and 150,000 or less (in terms of PMMA). If the number average molecular weight is less than 10,000, the strength of the resulting molded article becomes weak. If the number average molecular weight is more than 200,000, the melt viscosity of the flame-retardant polyester copolymer according to the present invention becomes high, and the molding and processing thereof become difficult.

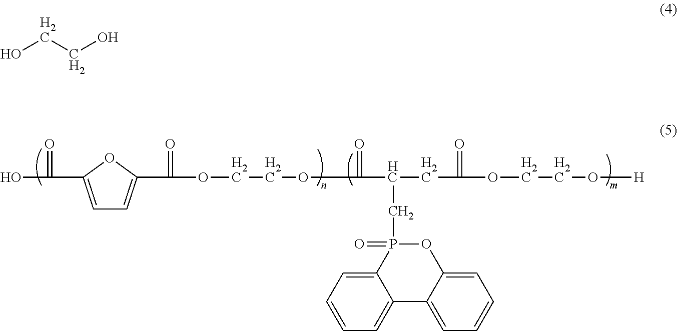

wherein n and m are each an integer of 1 or more and indicate a polymerization degree.

A synthetic process of the flame-retardant polyester copolymer, which is a second embodiment of the present invention, is then described.

This synthetic process has 2 steps. The first step is a step of obtaining an ester compound of the 2,5-furan dicarboxylic acid compound and the aliphatic or alicyclic diol (ethylene glycol), and a reaction product of itaconic acid, DOPO and the aliphatic or alicyclic diol (ethylene glycol). The second step is a step of conducting polycondensation of the compound or reaction product obtained in the first step, thereby obtaining the flame-retardant polyester copolymer of the formula (5). The first step and second step may be conducted separately or continuously. In this embodiment, the steps are favorably conducted continuously.

The reaction temperature for the first step is favorably 150° C. or more and 200° C. or less. If the reaction temperature is less than 150° C., the progress of the esterification of the 2,5-furan dicarboxylic acid compound and the aliphatic or alicyclic diol (ethylene glycol) or the reaction of itaconic acid, DOPO and the aliphatic or alicyclic diol (ethylene glycol) is slow. If the temperature is more than 200° C., unreacted 2,5-furan dicarboxylic acid compound, itaconic acid and DOPO remain though the progress of the esterification is accelerated. The temperature range for the polycondensation of the second step is favorably a range of 200° C. or more and 250° C. or less. If the temperature is less than 200° C., the reaction is slow. If the temperature is more than 250° C., a decomposition reaction occurs to cause dark coloring.

A specific example of the synthetic process of the flame-retardant polyester copolymer is shown below. In the first step, 2,5-furan dicarboxylic acid, ethylene glycol, itaconic acid and DOPO are gradually heated to a temperature of 150° C. or more and 200° C. or less while stirring together with a polymerization catalyst to conduct a reaction. The end point of this reaction can be easily confirmed at the point of time a reaction mixture turns transparent. At this point of time, the reaction mixture is an oligomer, not a polymer. In the second step, The reaction system is heated to a temperature of 200° C. or more and 250° C. or less, thereby causing an esterification reaction to initiate polycondensation intended to provide a high-molecular weight polymer.

The polycondensation stage (second step) is favorably performed under reduced pressure. The reason for it is that in the polycondensation reaction, water and ethylene glycol are formed as by-products, and these products are removed, thereby accelerating the reaction rate of the polycondensation. Specifically, the pressure is favorably 5 Pa or more and 700 Pa or less. Under a pressure less than 5 Pa, it is difficult to manufacture a reaction apparatus for polycondensation to keep this pressure. If the pressure is higher than 700 Pa, it takes a long time to conduct the polycondensation because the reaction rate thereof is slow. In addition, it is favorable to conduct solid phase polymerization by a publicly know process after obtaining the flame-retardant polyester copolymer so as to further heighten the molecular weight thereof.

The amounts of the monomers fed in the first step are then described in detail. The amount of ethylene glycol to be fed in the first step is favorably 1 to 3 molar equivalents of 2,5-furan dicarboxylic acid. Excess ethylene glycol and ethylene glycol formed with the progress of the polycondensation reaction can be removed out of the reaction system by distilling off them by reducing the pressure of the reaction system or by azeotropic distillation with another solvent, or by any other method.

The amount of itaconic acid and DOPO are favorably equimolar amounts. The amounts of itaconic acid and DOPO are each favorably 0.006 molar equivalents or more of 2,5-furan dicarboxylic acid. When the polyester copolymer of the formula (5) is synthesized in these feeding amounts, the content of a phosphorus atom incorporated in the flame-retardant polyester copolymer amounts to 0.1% by weight or more. In addition, the amounts of itaconic acid and DOPO are each more favorably 0.018 to 0.11 molar equivalents of 2,5-furan dicarboxylic acid.

When the polyester copolymer of the formula (5) is synthesized in these feeding amounts, the content of a phosphorus atom incorporated in the flame-retardant polyester copolymer is 0.3% by weight or more and 1.5% by weight or less. If the content exceeds 1.5% by weight, the strength and heat resistance of the flame-retardant polyester copolymer become weak. When the content of the phosphorus atom incorporated in the flame-retardant polyester copolymer falls within a range of 0.3% to 1.5% by weight, the flame retardancy corresponding to V-0 in the UL94 Standard is achieved.

The polymerization catalysts used in the synthesis of the flame-retardant polyester copolymer according to the present invention is then described. The catalyst used in the first step is favorably the acetate or carbonate of lead, zinc, manganese, calcium, cobalt or magnesium, a metal oxide or metal of magnesium, zinc, lead or antimony, an organic metal compound of tin, lead or titanium, or a tetravalent hafnium compound such as hafnium (IV) chloride or hafnium (IV) chloride.tetrahydrofuran (THF)₂. These catalysts may be used either singly or in any combination thereof. The end point of this first step is the point of time a reaction mixture turns transparent, and can be easily confirmed.

In the subsequent second step, the reaction system is heated to a temperature of 200° C. to 250° C. to initiate polycondensation reaction. The polycondensation reaction is favorably conducted under vacuum. As the catalyst optimum for this polycondensation, those specifically exemplified below may be used either singly or in any combination thereof. As the catalyst in the second step, may be used an acetate or carbonate of lead, zinc, manganese, calcium, cobalt or magnesium, a metal oxide of magnesium, zinc, lead or antimony, or an organic metal compound of tin, lead or titanium. As the catalyst used in the first and second steps, may be used an organic metal compound of tin and an organic metal compound of titanium, such as titanium alkoxide. As for the time the catalysts are added, the catalysts may be added separately in the first and second steps, or the catalyst used in the second step may be added from the beginning of the first step. Upon the addition of the catalyst, the catalyst may be dividedly added in plural times.

The molded article of the flame-retardant polyester copolymer, which is a third embodiment of the present invention, is then described.

The flame-retardant polyester copolymer obtained according to the process of the present invention is a thermoplastic resin. This flame-retardant polyester copolymer has physical properties fully withstandable with respect to the specifications for optical apparatus, bottles and casing materials. This flame-retardant polyester copolymer may be used as a thermoplastic resin for molding into a desired shape. No particular limitation is imposed on a molding method. For example, compression molding, extrusion or injection molding may be used. Necessary amounts of additives such as a colorant, an internal parting agent, an antioxidant, an ultraviolet absorbent and various fillers may be added to the flame-retardant polyester copolymer obtained by the above-described process.

As favorable use examples of the molded article obtained by molding the flame-retardant polyester copolymer obtained by the process according to the present invention, may be mentioned uses as components for toner containers for electrophotography, packaging resins, and casings of business machines such as copying machines and printers, and cameras.

### EXAMPLES

Examples of the present invention will hereinafter be described to specifically explain the flame-retardant polyester copolymer according to the present invention. the technical scope of the present invention is not limited thereto. The following apparatus and conditions were used in the evaluation of the flame-retardant polyester copolymers in Examples 1 to 3 and Comparative Examples 1 and 2.

1. Molecular Weight Measurement

Analytical instrument: Alliance 2695 manufactured by Waters Co.
Detector: Optilab rEX manufactured by Wyatt Co.
Eluent: Hexafluoroisopropanol solution containing sodium trifluoroacetate at a concentration of 5 mM.
Flow rate: 0.8 ml/min.
Calibration curve: A calibration curve was prepared by using a PMMA standard sample available from Polymer Laboratories Co. to measure the molecular weight of each flame-retardant polyester copolymer.
Column temperature: 40° C.

2. Measurement of Glass Transition Temperature (Tg)*¹ *1: After a sample was melted in a first scan to release thermal hysteresis, the sample was quickly cooled to −30° C., and second heating was then started. A temperature observed at this time was regarded as Tg.

Apparatus name: A differential scanning calorimeter (DSC) manufactured by TA Instruments.
Pan: An aluminum pan.
Sample weight: 2 mg to 3 mg.
Temperature at which heating is started: 30° C.
Rate of heating: 10° C./min in first scan and 5° C./min in second scan.

### Atmosphere: Nitrogen.

3. Measurement of Thermal Decomposition Temperature (Td)*² *2: The temperature at which 10% loss in weight was observed was regarded as Td.

Apparatus name: A thermogravimetric apparatus (TGA) manufactured by TA Instruments.
Pan: A platinum pan.
Sample weight: 3 mg.
Temperature at which heating is started: 30° C.
Measurement mode: Dynamic rate method*³. *3: A measurement mode in which the heating rate is controlled according to the degree of weight change to improve resolution.

### Atmosphere: Nitrogen.

4. Vertical Burning Test

Method: UL94 Standard, a vertical burning test.
Specimen: 125 mm×12.5 mm×2 mm (thickness).

5. Kneading

Apparatus: A twin-screw kneader Laboplast Mill (trade name, screw diameter: 26 mm, L (length)/D (diameter): 25, manufactured by Toyo Seiki Seisakusho Co., Ltd.).

6. Molding Machine

Apparatus: SE18DU (trade name, screw diameter: 20 mm, manufactured by Sumitomo Heavy Industries, Ltd.).

### Example 1

A 1-L stainless steel-made separable flask equipped with a nitrogen inlet tube, a fractionating-cooling column and a stainless steel-made agitating blade was provided. This separable flask was charged with 578.8 g (3.71 mol) of 2,5-furan dicarboxylic acid, 468.7 g (7.55 mol) of ethylene glycol, 8.8 g (0.07 mol) of itaconic acid and 14.6 g (0.07 mol) of DOPO, and then charged with 0.26 g (1.3 mmol) of titanium ethoxide and 0.24 g (1.15 mmol) of monobutyltin oxide as catalysts. After nitrogen was introduced into the separable flask and the separable flask was then vacuum-deaerated by holding it for 10 minutes at ordinary temperature under vacuum, nitrogen was introduced to return the pressure within the separable flask to ordinary pressure. This process was repeated 3 times, thereby eliminating oxygen from the system to inhibit a side reaction caused by oxygen. The separable flask was then immersed in an oil bath the temperature of which was 160° C. to heat the contents, thereby conducting a reaction for 4 hours.

When the reaction was then continued for 4 hours at 180° C. and 2.5 hours at 200° C., the contents turned transparent. Then, 0.26 g (1.15 mmol) of titanium ethoxide and 0.22 g (1.1 mmol) of monobutyltin oxide were added, and a vacuum pump was connected to the reactor to initiate reduction of the pressure. A polycondensation reaction was conducted for 15.5 hours at a reaction temperature of 230° C. under reduced pressure (133 Pa). A flame-retardant polyester copolymer obtained in this manner had a number average molecular weight as high as 41,000 (in terms of PMMA), a glass transition temperature (Tg) of 86° C. and a thermal decomposition temperature (Td) of 375° C. The resultant flame-retardant polyester copolymer was then dried for 6 hours or more by a vacuum dryer of 90° C. and then molded into a specimen of 125 mm×12.5 mm×2 mm under conditions of a cylinder temperature of 200° C. and a mold temperature of 50° C. by means of a molding machine to conduct a V test according to UL94 Standard.

### Example 2

A 1-L stainless steel-made separable flask equipped with a nitrogen inlet tube, a fractionating-cooling column and a stainless steel-made agitating blade was provided. This separable flask was charged with 528.3 g (3.38 mol) of 2,5-furan dicarboxylic acid, 448.2 g (7.22 mol) of ethylene glycol, 29.4 g (0.23 mol) of itaconic acid and 48.8 g (0.23 mol) of DOPO, and then charged with 0.25 g (1.1 mmol) of titanium ethoxide and 0.23 g (1.1 mmol) of monobutyltin oxide as catalysts. After nitrogen was introduced into the separable flask and the separable flask was then vacuum-deaerated by holding it for 10 minutes at ordinary temperature under vacuum, nitrogen was introduced to return the pressure within the separable flask to ordinary pressure. This process was repeated 3 times, thereby eliminating oxygen from the system to inhibit a side reaction caused by oxygen. The separable flask was then immersed in an oil bath the temperature of which was 160° C. to heat the contents, thereby conducting a reaction for 3 hours.

When the reaction was then continued for 1 hour at 180° C. and 4 hours at 200° C., the contents turned transparent. Then, 0.24 g (1.1 mmol) of titanium ethoxide and 0.22 g (1.1 mmol) of monobutyltin oxide were added, and a vacuum pump was connected to the reactor to initiate reduction of the pressure. A polycondensation reaction was conducted for 24 hours and 20 minutes at a reaction temperature of 230° C. under reduced pressure (133 Pa). A flame-retardant polyester copolymer obtained in this manner had a number average molecular weight as high as 40,000 (in terms of PMMA), a glass transition temperature (Tg) of 83° C. and a thermal decomposition temperature (Td) of 378° C. The resultant flame-retardant polyester copolymer was then dried for 6 hours or more by a vacuum dryer of 90° C. and then molded into a specimen of 125 mm×12.5 mm×2 mm under conditions of a cylinder temperature of 190° C. and a mold temperature of 50° C. by means of a molding machine to conduct a V test according to UL94 Standard.

### Example 3

A 1-L stainless steel-made separable flask equipped with a nitrogen inlet tube, a fractionating-cooling column and a stainless steel-made agitating blade was provided. This separable flask was charged with 492.3 g (3.15 mol) of 2,5-furan dicarboxylic acid, 433.5 g (6.98 mol) of ethylene glycol, 44.1 g (0.34 mol) of itaconic acid and 73.2 g (0.34 mol) of DOPO, and then charged with 0.24 g (1.05 mmol) of titanium ethoxide and 0.22 g (1.05 mmol) of monobutyltin oxide as catalysts. After nitrogen was introduced into the separable flask and the separable flask was then vacuum-deaerated by holding it for 10 minutes at ordinary temperature under vacuum, nitrogen was introduced to return the pressure within the separable flask to ordinary pressure. This process was repeated 3 times, thereby eliminating oxygen from the system to inhibit a side reaction caused by oxygen. The separable flask was then immersed in an oil bath the temperature of which was 160° C. to heat the contents, thereby conducting a reaction for 3 hours.

When the reaction was then continued for 1 hour at 180° C. and 4 hours at 200° C., the contents turned transparent. Then, 0.24 g (1.05 mmol) of titanium ethoxide and 0.22 g (1.05 mmol) of monobutyltin oxide were added, and a vacuum pump was connected to the reactor to initiate reduction of the pressure. A polycondensation reaction was conducted for 21 hours at a reaction temperature of 230° C. under reduced pressure (133 Pa). A flame-retardant polyester copolymer obtained in this manner had a number average molecular weight as high as 40,000 (in terms of PMMA), a glass transition temperature (Tg) of 79° C. and a thermal decomposition temperature (Td) of 378° C. The resultant flame-retardant polyester copolymer was then dried for 6 hours or more by a vacuum dryer of 90° C. and then molded into a specimen of 125 mm×12.5 mm×2 mm under conditions of a cylinder temperature of 190° C. and a mold temperature of 50° C. by means of a molding machine to conduct a V test according to UL94 Standard.

### Comparative Example 1

A 10-L stainless steel-made separable flask equipped with a nitrogen inlet tube, a fractionating-cooling column and a stainless steel-made agitating blade was provided. This separable flask was charged with 2,300 g (14.7 mol) of 2,5-furan dicarboxylic acid and 2,758 g (44.2 mol) of ethylene glycol, and then charged with 4.2 g (12.3 mmol) of titanium ethoxide and 4.1 g (19.6 mmol) of monobutyltin oxide as catalysts. Agitation was started while introducing nitrogen, and at the same time, a power source of a mantle heater was turned on to heat the contents toward 150° C. In Comparative Example 1, all the temperatures indicate internal temperatures. Around the time the temperature reached 150° C., outflow of by-product water attending on a condensation reaction started. When the reaction was continued for each 1 hour at 160° C. and 165° C., for each 0.5 hours at 170° C. and 175° C., and for 2 hours at 210° C., the contents turned transparent. At the time outflow of water distilled became weak, the reaction system was connected to a vacuum pump to initiate reduction of the pressure. The pressure was reduced to 133 Pa in about 2 hours.

The vacuum was released once with nitrogen, and 2.1 g (6.2 mmol) of titanium butoxide and 2.1 g (10.1 mmol) of monobutyltin oxide were added. The pressure was reduced to 133 Pa in about 30 minutes. Hereinafter, the reaction was continued for 14 hours under the reduced pressure. Polyethylene-2,5-furan dicarboxylate obtained in this manner had a number average molecular weight as high as 63,000 (in terms of PMMA), a glass transition temperature (Tg) of 87° C. and a thermal decomposition temperature (Td) of 364° C. The resultant polyethylene-2,5-furan dicarboxylate was then dried for 6 hours or more by a vacuum dryer of 90° C. and then molded into a specimen of 125 mm×12.5 mm×2 mm under conditions of a cylinder temperature of 215° C. and a mold temperature of 50° C. by means of a molding machine to conduct a V test according to UL94 Standard.

### Comparative Example 2

An organic phosphorous flame retardant was prepared according to Preparation Example 1 described in WO 2007/040075. Specific procedure is as follows.

A 2-L glass-made separable flask equipped with a nitrogen inlet tube, a fractionating-cooling column and a stainless steel-made agitating blade was provided. This separable flask was charged with 69.9 g (0.54 mol) of itaconic acid, 116.1 g (0.54 mol) of DOPO and 186.4 g (3.0 mol) of ethylene glycol. After nitrogen was introduced into the separable flask and the separable flask was then vacuum-deaerated by holding it for 10 minutes at ordinary temperature under vacuum, nitrogen was introduced to return the pressure within the separable flask to ordinary pressure. This process was repeated 3 times, thereby eliminating oxygen from the system to inhibit a side reaction caused by oxygen. Agitation was started while introducing nitrogen, and at the same time, a power source of an oil bath was turned on to heat the contents toward 120° C. The contents were continuously heated to an internal temperature of 200° C. over 1 hour to conduct a reaction for about 10 hours. To a solution obtained at this time, were added 0.12 g of zinc acetate and 0.12 g of antimony trioxide, and the reaction system was connected to a vacuum pump to initiate reduction of the pressure. The pressure was reduced to 133 Pa in about 30 minutes. Hereinafter, the polycondensation reaction was continued for 5 hours under conditions of 133 Pa or lee and 220° C. An organic phosphorous flame retardant obtained in this manner had a number average molecular weight of 13,000 (in terms of PMMA), a glass transition temperature (Tg) of 64° C. and a thermal decomposition temperature (Td) of 362° C.

The resultant organic phosphorous flame retardant was then kneaded with PET (trade name: Unitika Polyester Resin NEH-2050, product of UNITIKA, Co. LTD.) and polycarbonate (trade name: PANLIGHT L-1225L, product of TEIJIN CHEMICALS Co. LTD.) in a kneader. The kneading was conducted with a composition of 100 parts by weight of PET, parts by weight of the organic phosphorous flame retardant, 30 parts by weight of the polycarbonate and 1.5 parts by weight of IRGANOX 1010 (trade name, product of Ciba Japan Co.) according to Example 1 described in WO 2007/040075. At this time, the cylinder temperature of the kneader was set to from 235° C. to 250° C. to melt the resin and obtain pellets. The resultant pellets were then molded into a specimen of 125 mm×12.5 mm×2 mm under conditions of a mold temperature of 50° C. and a cylinder temperature of from 240° C. to 270° C. by means of a molding machine to conduct a V test according to UL94 Standard.

Feeding amounts of the respective components in Examples 1 to 3 and Comparative Example 1, and the measured results of the molecular weights, glass transition temperatures and thermal decomposition temperatures of the resultant flame-retardant polyester copolymers are shown in Table 1 collectively. Feeding amounts of the respective components upon the synthesis of the organic phosphorous flame retardant in Comparative Example 2, and the measured results of the molecular weight, glass transition temperature and thermal decomposition temperature of the resultant organic phosphorous flame retardant are also shown in Table 1 collectively. The compositional ratio in Comparative Example 2 is shown in Table 2 collectively. The results of the burning test in all Examples and Comparative Examples are shown in Table 3 collectively. The criterion of the V test is shown in Table 4.

TABLE 1

| | | | | Comp. | Comp. |
|---|---|---|---|---|---|
| | Ex. 1 | Ex. 2 | Ex. 3 | Ex. 1 | Ex. 2 |
| FDCA g (mol) | 578.8 | 528.3 | 492.2 | 2300 | 0 |
| | (3.71) | (3.38) | (3.15) | (14.7) | |
| EG g (mol) | 468.7 | 448.2 | 433.5 | 2758 | 186.4 |
| | (7.55) | (7.22) | (6.98) | (44.2) | (3.00) |
| IA g (mol) | 8.8 | 29.4 | 44.1 | 0 | 69.9 |
| | (0.07) | (0.23) | (0.34) | | (0.54) |
| DOPO g (mol) | 14.6 | 48.8 | 73.2 | 0 | 116.1 |
| | (0.07) | (0.23) | (0.34) | | (0.54) |
| TET g (mol) | 0.52 | 0.49 | 0.48 | 0 | 0 |
| | (2.3) | (2.2) | (2.1) | | |
| TBT g (mol) | 0 | 0 | 0 | 6.2 | 0 |
| | | | | (18.2) | |
| MBTO g (mol) | 0.47 | 0.45 | 0.44 | 6.1 | 0 |
| | (2.3) | (2.2) | (2.2) | (29.2) | |
| ZA g (mol) | 0 | 0 | 0 | 0 | 0.12 |
| | | | | | (0.4) |
| ATO g (mol) | 0 | 0 | 0 | 0 | 0.12 |
| | | | | | (0.7) |
| Mn × 10⁻⁴ | 4.1 | 4.0 | 4.0 | 6.3 | 1.3 |
| Tg ° C. | 86 | 83 | 79 | 87 | 64 |
| Td ° C. | 375 | 378 | 378 | 364 | 362 |

FDCA: Furan-2,5-dicarboxylic acid.
EG: Ethylene glycol.
DOPO: 9,10-Dihydro-9-oxa-10-phosphaphenanthrene-10-oxide.
TET: Tetra-n-ethoxytitanium.
TBT: Tetra-n-butoxytitanium.
MBTO: Monobutyltin oxide.
ZA: Zinc acetate.
ATO: Antimony trioxide.
Mn: Number average molecular weight (in terms of PMMA).
Tg: Glass transition temperature.
Td: Thermal decomposition temperature.

TABLE 2

| | | | Comp. Ex. 2 |
|---|---|---|---|
| Formulation | Thermoplastic | PET | 100 |
| (parts) | polyester | | |
| | Organic | | 10 |
| | phosphorus flame | | |
| | retardant | | |
| | Amorphous resin | PC | 30 |
| | Stabilizer | IRGANOX 1010 | 1.5 |

TABLE 3

| | Content of | | | | | |
|---|---|---|---|---|---|---|
| | phosphorus | | | | | |
| | atom (% by | t1 | Cotton | t2 | Cotton | |
| | weight) | (s) | ignition | (s) | ignition | Class |
| Ex. 1 | 0.3 | 0 | (2) | 0 | (2) | Corresponding |
| | | 0 | (2) | 0 | (2) | to V-0 |
| | | 0 | (2) | 0 | (2) | |
| | | 0 | (2) | 0 | (2) | |
| | | 0 | (2) | 0 | (2) | |
| Ex. 2 | 1.0 | 0 | (2) | 0 | (2) | Corresponding |
| | | 0 | (2) | 0 | (2) | to V-0 |
| | | 0 | (2) | 0 | (2) | |
| | | 0 | (2) | 0 | (2) | |
| | | 0 | (2) | 0 | (2) | |
| Ex. 3 | 1.5 | 0 | (2) | 0 | (2) | Corresponding |
| | | 0 | (2) | 0 | (2) | to V-0 |
| | | 0 | (2) | 0 | (2) | |
| | | 0 | (2) | 0 | (2) | |
| | | 0 | (2) | 0 | (2) | |
| Comp. | 0 | 6 | (3) | — | (4) | No |
| Ex. 1 | | 8 | (3) | — | (4) | corresponding |
| | | 7 | (3) | — | (4) | class |
| | | 8 | (3) | — | (4) | |
| | | 8 | (3) | — | (4) | |
| Comp. | 0.59 | 1 | (3) | 1 | — | Corresponding |
| Ex. 2 | | 0 | (1) | 1 | (3) | to V-2 |
| | | 0 | (1) | 1 | (3) | |
| | | 0 | (1) | 1 | (3) | |
| | | 0 | (1) | 1 | (3) | |

Cotton ignition: (1) No drip, (2) Drips but no cotton ignition, (3) Drips and cotton ignition, (4) Burning up to clamp.
t1: Duration of flaming combustion after first release from the flame.
t2: Duration of flaming combustion after second release from the flame.

TABLE 4

| | V-0 | V-1 | V-2 |
|---|---|---|---|
| Total duration of flaming | 10 sec. Or | 30 sec. Or | 30 sec. Or |
| combustion of each sample after | less | less | less |
| first or second release from | | | |
| the flame | | | |
| Total duration of flaming | 50 sec. Or | 250 sec. Or | 250 sec. Or |
| combustion after 10-times | less | less | less |
| releases from the flame | | | |
| Total duration of flaming | 30 sec. Or | 60 sec. Or | 60 sec. Or |
| combustion and flammable | less | less | less |
| state after second release | | | |
| from the flame | | | |
| Cotton ignited by flaming | NO | NO | YES |
| drips | | | |

As apparent from Table 3, it is understood that when the content of the phosphorus atom is from 0.3% by weight to 1.5% by weight, the result of the burning test corresponds to V-0, and such a polyester copolymer has good flame retardancy. As a result, the polyester copolymer can be used in members of which high flame retardancy is required, such as casings and internal parts of copying machines. According to the process described in WO 2007/040075, the specimen could not satisfy the flame retardancy corresponding to v-0 in the thickness of 2 mm. It has been apparent from these results that high flame retardancy is developed for the first time by copolymerizing itaconic acid and DOPO with PEF.

As uses of the molded articles obtained from the flame-retardant polyester copolymer according to the present invention, may be mentioned uses as components for toner containers for electrophotography, packaging resins, and casings of business machines such as copying machines and printers, and cameras,

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-267967, filed Nov. 25, 2009, which is hereby incorporated by reference herein in its entirety.

What is claimed is:

1. A production process of a flame-retardant polyester copolymer, comprising a first step of adding a catalyst to a 2,5-furan dicarboxylic acid compound represented by the following formula (1), an aliphatic or alicyclic diol, itaconic acid and 9,10-dihydro-9-oxa-10-phosphaphenanthrene-10-oxide to obtain an oligomer, and a second step of adding a catalyst to the oligomer obtained in the first step to conduct polycondensation, thereby obtaining the flame-retardant polyester copolymer 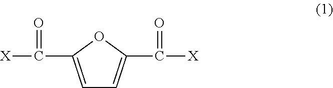
wherein X is a hydroxyl group, alkoxy group or halogen atom.

2. The production process according to claim 1, wherein a reaction temperature of the first step is 150° C. or more and 200° C. or less.

3. The production process according to claim 1, wherein the catalyst added in the first step is an organic metal compound of tin or an organic metal compound of titanium.

4. The production process according to claim 1, wherein a reaction temperature of the second step is 200° C. or more and 250° C. or less, and a pressure within a reaction vessel is 5 Pa or more and 700 Pa or less.

5. The production process according to claim 1, wherein the catalyst added in the second step is an organic metal compound of tin or an organic metal compound of titanium.

6. The production process according to claim 1, wherein an amount of mass of 9,10-dihydro-9-oxa-10-phosphaphenanthrene-10-oxide in the first step is 0.018 mol or more and 0.11 mol or less per mol of 2,5-furan dicarboxylic acid.

7. A flame-retardant polyester copolymer obtained by polycondensing an ester compound of a 2,5-furan dicarboxylic acid compound represented by the following formula (1) and an aliphatic or alicyclic diol, itaconic acid and 9,10-dihydro-9-oxa-10-phosphaphenanthrene-10-oxide, the flame-retardant polyester copolymer having a number average molecular weight of 10,000 or more and 200,000 or less. 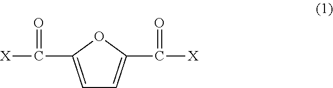
wherein X is a hydroxyl group, alkoxy group or halogen atom.

8. The flame-retardant polyester copolymer according to claim 7, wherein the aliphatic or alicyclic diol is ethylene glycol.

9. A molded article obtained by molding the flame-retardant polyester copolymer according to claim 7.
